(19) United States
(12) Patent Application Publication
(10) Pub. No.: US 2010/0168937 A1
(43) Pub. Date: Jul. 1, 2010

(54) Method for Flight Control of a Plurality of Aircraft Flying in Formation

(75) Inventors: Marco Willem Soijer, Senden (DE); Manfred Zoberbier, Ulm (DE); Roland Goerke, Dornstadt (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 12/063,186

(22) PCT Filed: Aug. 3, 2006
(86) PCT No.: PCT/DE06/01354

§ 371 Date: Feb. 7, 2008

(30) Foreign Application Priority Data
Aug. 9, 2005 (DE) 10 2005 038 017.4

(51) Int. Cl. G05D 1/00

(52) U.S. Cl. 701/11

(57) ABSTRACT

In a method for the flight control of a plurality of aircraft flying in formation with respect to one another, correction signals are generated for an autopilot system or a command display in order to allow one or more following aircraft within the formation to follow a lead aircraft in the formation in a predeterminable relative position. A nominal trajectory of the following aircraft, parallel to the trajectory (1) of the lead aircraft, is calculated at each instantaneous position P′_{act} of the following aircraft, which trajectory runs through the instantaneous actual position P′_{act} and a reference point P′_{RP}. (The reference point P′_{RP} is the projection of a point P_{RP}, which is separated by the longitudinal nominal distance xₙₒₘ between the lead aircraft and the following aircraft, on the trajectory of the lead aircraft, taking into account the lateral and vertical actual distances y_{act} and z_{act} between the trajectory of the lead aircraft and that of the following aircraft. The trajectory of the following aircraft is calculated taking into account the lateral actual distance y_{act} from the trajectory of the lead aircraft by determining support points P′ on the trajectory of the following aircraft which have the same time coordinates as the corresponding support points on the trajectory of the lead aircraft. The correction signals are determined by i) measuring the longitudinal, lateral and vertical actual distances x_{act}, v_{act} and z_{act} between the trajectory of the lead aircraft and that of the following aircraft at the instantaneous position P′_{act} of the following aircraft, ii) calculating the longitudinal deviation Δx, the vertical deviation Δz and the lateral deviation Δy of the instantaneous actual position P′_{act} and of the nominal position P′ₙₒₘ of the following aircraft from the respective nominal values xₙₒₘ, zₙₒₘ, yₙₒₘ and the measured actual values x_{act}, z_{act}, y_{act}, iii) calculating the nominal speed and the nominal acceleration of the following aircraft at the point P′_{RP}, and iv) calculating the nominal curvature, the nominal climbing rate and the nominal curvature angle Ψ of the trajectory of the following aircraft at the instantaneous position P′_{act} of the following aircraft.

This application is a national stage of PCT International Application No. PCT/DE2006/001354, filed Aug. 3, 2006, which claims priority under 35 U.S.C. §119 to German Patent Application No. 10 2005 038 017.4, filed Aug. 9, 2005, the entire disclosure of which is herein expressly incorporated by reference.

### BACKGROUND AND SUMMARY OF THE INVENTION

The invention relates to a method for the flight control of a plurality of aircraft flying in formation.

Flight control in formation flights is discussed, for example, in Published U.S. Patent No. US 2005/0165516 A1 and U.S. Pat. No. 6,587,757 B2, which relates to a coordinated flight of a plurality of aircraft. Automatic flight control in a formation flight requires that reference signals be supplied to the flight control system of a following aircraft in order to keep the following aircraft in a desired position relative to the lead aircraft. The reference signals must sort out external disturbances, such as wind gusts or previous control errors, and must compensate for the different dynamics of the trajectory of the following aircraft, particularly with respect to a larger or smaller turning radius.

The problem of an automated aircraft close-formation flight concerns the determination of the trajectory of a following aircraft as well as its position relative to a lead aircraft. The determination of the trajectory of an aircraft in this case normally comprises two steps, specifically the reconstruction of the trajectory of the lead aircraft and the determination of the trajectory of the following aircraft as a derivation of the trajectory of the lead aircraft while taking into account a given longitudinal, lateral and vertical distance between the lead aircraft and the following aircraft.

In a close-formation flight, the distance between the lead aircraft and the following aircraft is typically three wingspans or less. As a result, the flight-dynamic movements of the following aircraft (particularly its speed and acceleration) are approximately identical to those of the lead aircraft.

In the case of a tactical formation flight, the lateral distance between the lead aircraft and the following aircraft is typically up to 300 m. The longitudinal distance in time or length units is typically between 10 sec. or 0.3 NM (1 NM—1 nautical mile) and 1 min. or 3 NM. However, distances of up to 100 NM are also possible. Thus, in an open formation flight, the flight dynamics of the following aircraft cannot be considered identical with those of the lead aircraft. During a turning flight, the larger lateral distance requires a speed change in order to compensate the enlarged or reduced length of the trajectory.

Generally, with respect to automatic flight control, a distinction is made between a synchronous mode and a tunnel mode. In the synchronous mode, the speed changes and altitude changes of the lead aircraft are immediately correspondingly executed by the following aircraft. In the tunnel mode, the speed changes and altitude changes of the lead aircraft will be executed by the following aircraft when the following aircraft reaches exactly the position (while taking into account the lateral distance) in which the lead aircraft initiated the change.

U.S. Pat. No. 4,674,710 discloses an SKE (Station Keeping Equipment) product for an automatic open formation flight. It is based on the mutual exchange of radio data between the aircraft within the flight formation. Directional antennas are used for determining the arrangement of the aircraft within the formation relative to a following aircraft. The system was developed in order to obtain a formation of aircraft during a straight flight or during a turning flight. However, the method on which the system is based is not very suitable for a use during highly dynamic flying maneuvers. To secure the formation during a turning flight, the method according to U.S. Pat. No. 4,674,710 requires a fixed rolling rate, a fixed banking angle as well as a fixed turning radius.

A flight control method of the generic type addressed herein is disclosed in U.S. Pat. No. 6,405,124 B1, in which a nominal trajectory with a nominal distance, on which the following aircraft follows the lead aircraft, is generated with respect to a predetermined trajectory. In this case, a virtual aircraft is assigned to the following aircraft and is guided parallel to the following aircraft on the actual trajectory at the nominal distance. The deviation of the virtual aircraft from the actual trajectory is used as the controlled variable in order to control the real aircraft onto the nominal trajectory.

One object of the invention is to provide a method of the above-mentioned type, in which the formation of aircraft can be maintained, even during highly dynamic flying maneuvers.

This and other objects and advantages are achieved by the flight control method according to the invention, in which a nominal trajectory of the following aircraft, which is parallel to the trajectory of the lead aircraft, is calculated at each instantaneous position P′_{act} of the following aircraft. The nominal trajectory of the following aircraft runs through the instantaneous actual position P′_{act} and a reference point P_{RP}. The latter is the projection of a point P_{RP}, which is separated by the longitudinal nominal distance xₙₒₘ between the lead aircraft and the following aircraft, on the trajectory of the lead aircraft, taking into account the lateral and vertical actual distances y_{act} and z_{act} between the trajectory of the lead aircraft and that of the following aircraft. The trajectory (2) of the following aircraft is calculated taking into account the lateral actual distance y_{act} from the trajectory (1) of the lead aircraft by determining support points P′ on the trajectory (2) of the following aircraft which have the same time coordinates as the corresponding support points on the trajectory (1) of the lead aircraft. The determination of correction signals comprises the following steps:
Measurement of the longitudinal actual distance x_{act}, of the lateral actual distance y_{act} and of the vertical actual distance z_{act} between the trajectory of the lead aircraft and that of the following aircraft at the instantaneous position P′_{act} of the following aircraft,
Calculation of the longitudinal, vertical and lateral deviations Δx, Δz and Δy of the instantaneous actual position P′_{act} and of the nominal position P′ₙₒₘ of the following aircraft, from the respective nominal values xₙₒₘ, zₙₒₘ, yₙₒₘ and the measured actual values x_{act}, z_{act}, y_{act},
Calculation of the nominal speed and the nominal acceleration of the following aircraft at the point P′_{RP},
Calculation of the nominal curvature, of the nominal climbing rate and of the nominal curvature angle Ψ of the trajectory of the following aircraft of the following aircraft at the instantaneous position P′_{act} of the following aircraft.

In an advantageous embodiment of the process, a number of supporting points P are determined on the trajectory of the lead aircraft, for which supporting points P the spatial coordinates are known and a time coordinate is known with respect to a time base uniform for the formation.

Expediently, the vertical deviation Δz between the trajectory of the following aircraft and the nominal position is determined.

The ground course angle Ψ of the following aircraft is determined particularly as the angle between the direction of the trajectory of the following aircraft at its instantaneous position P′_{act}, and true north.

The reference point P_{RP} on the trajectory of the lead aircraft and the reference point P′_{RP} on the trajectory of the following aircraft advantageously have the same time coordinate.

The trajectory of the following aircraft advantageously is calculated taking into account the lateral actual distance y_{act} from the trajectory of the lead aircraft by the determination of support points P′ on the trajectory of the following aircraft which have the same time coordinates as the corresponding support points on the trajectory of the lead aircraft.

According to the invention, a following aircraft can be controlled along a calculated trajectory, with control relative to the three space axes in each case taking place separately and independently of one another. The flight control with respect to each space can take place automatically by an autopilot system or an autothrottle system. According to the invention, the following parameters are determined for generating corresponding correction signals for flight control with respect to the individual space axes:

With respect to the longitudinal space axis: the longitudinal deviation Δx (difference between reference point P_{RP} and actual position P′_{act} on the trajectory of the following aircraft), the nominal speed and the nominal acceleration;

With respect to the lateral space axis: the lateral deviation Δy (difference between the lateral actual deviation y_{act} and the nominal deviation yₙₒₘ), the curvature of the trajectory of the following aircraft, the ground course angle;

With respect to the vertical space axis: the vertical deviation Δz (in the tunnel mode: difference between the actual altitude of the following aircraft and the sum of the predetermined deviation zₙₒₘ and the altitude of the support point which corresponds to the projection of the actual position of the following aircraft on the trajectory of the lead aircraft; in the synchronous mode: the difference between the actual altitude of the following aircraft and the actual altitude of the lead aircraft plus the predetermined deviation zₙₒₘ) and the nominal climbing rate.

The flight control method according to the invention is a function of the time coordinates of the respective positions of the lead aircraft and the following aircraft. According to this method, the individual control axes are uncoupled from one another with respect to the longitudinal distance, the vertical distance and the lateral distance between the lead aircraft and the following aircraft as well as the respective deviations contained therein. The position of the following aircraft with respect to a control axis can therefore be tracked independently of the other control axes. This uncoupling is achieved by introducing reference point P′_{RP} on the trajectory of the following aircraft. By means of reference point P′_{RP}, the longitudinal nominal distance xₙₒₘ and the lateral actual distance y_{act} as well as the vertical actual distance z_{act} are linked with one another. Expediently, the nominal trajectory of the following aircraft is calculated continuously with respect to each actual position P′_{act} of the following aircraft.

By the method according to the invention, it is possible to calculate the trajectory of the following aircraft by time-tagged space coordinates resulting from time-tagged measurements of the spatial position of the lead aircraft on its trajectory. In the following, the position of an aircraft is therefore understood to be a 4-dimensional quantity which is composed of one time coordinate and three space coordinates. This information can ideally be determined by the onboard navigation system of the lead aircraft. Advantageously, the time-tagged position of the lead aircraft is transmitted to the following aircraft within the formation by radio transmission.

The method according to the invention can of course also be used when the lead aircraft of a formation is a following aircraft of a higher-ranking formation.

Other objects, advantages and novel features of the present invention will become apparent from the following detailed description of the invention when considered in conjunction with the accompanying drawings.

### BRIEF DESCRIPTION OF THE DRAWINGS

FIG. 1 is a plane schematic representation of a trajectory of a lead aircraft with support points P as well as an estimated trajectory of a following aircraft with calculated support points P′

FIG. 2 is a schematic representation for calculating the support point P′_{RP} on the trajectory of the following aircraft in the case of a concave and convex flying turn;

FIG. 3 is a schematic representation for calculating the nominal speed and the nominal acceleration;

FIG. 4 is a schematic representation for calculating the curvature radius of a trajectory; and

FIG. 5 is a schematic three-dimensional representation of a situation in a formation flight, for illustrating the deviations of the trajectory of the following aircraft from the predetermined values.

### DETAILED DESCRIPTION OF THE INVENTION

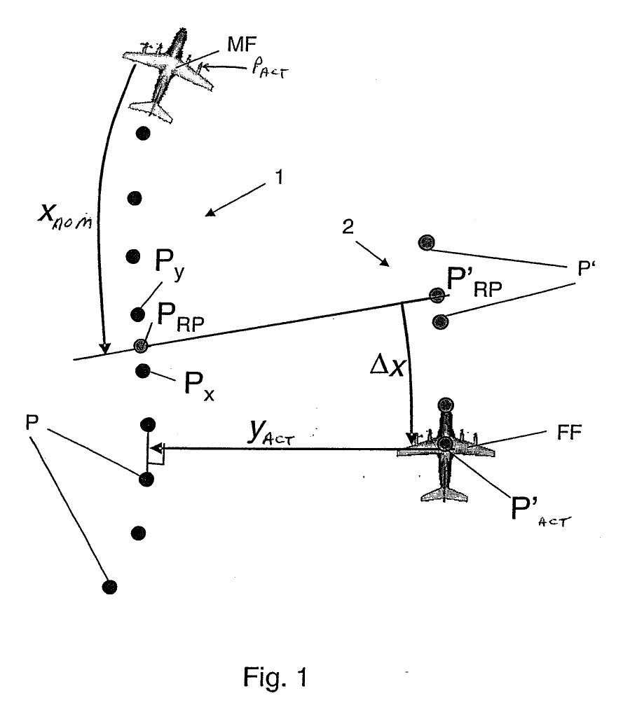

In a planar representation, FIG. 1 shows a trajectory 1 of a lead aircraft MF with support points P, as well as an estimated trajectory 2 of a following aircraft FF with support points P′ that were calculated based on the support points P on the trajectory 1 of the lead aircraft.

Reference symbol Xₙₒₘ indicates the predetermined relative longitudinal distance between the lead aircraft MF and the following aircraft FF. The lateral actual distance between the lead aircraft MF and the following aircraft FF is marked y_{act}. (The predetermined vertical distance is not shown.) The longitudinal nominal distance Xₙₒₘ is expediently determined before the aircraft form a formation, for example, by the pilots. A corresponding situation applies to a predetermined vertical and lateral nominal distance. The distances can be indicated either in time units or distance units.

For the determination of a support point P_{RP} for the reference point on the trajectory of the lead aircraft, the longitudinal distance xₙₒₘ from the actual position P_{act} of the lead aircraft along the trajectory 1 is determined. The distance xₙₒₘ is determined either with respect to the time or distance, according to mathematically known processes, such as integration by way of the length of travel or the time segment.

If the reference point P_{RP} calculated in this manner is between two adjacent support points Pₓ and P_{y}, the support point pertaining to reference point P_{RP} is calculated by interpolation. While taking into account the lateral and vertical actual distances y_{act} and z_{act}, a support point P′_{RP} is now calculated. According to the definition, P′_{RP} is on the estimated trajectory 2 of the following aircraft and is parallel to the trajectory 1 of the lead aircraft.

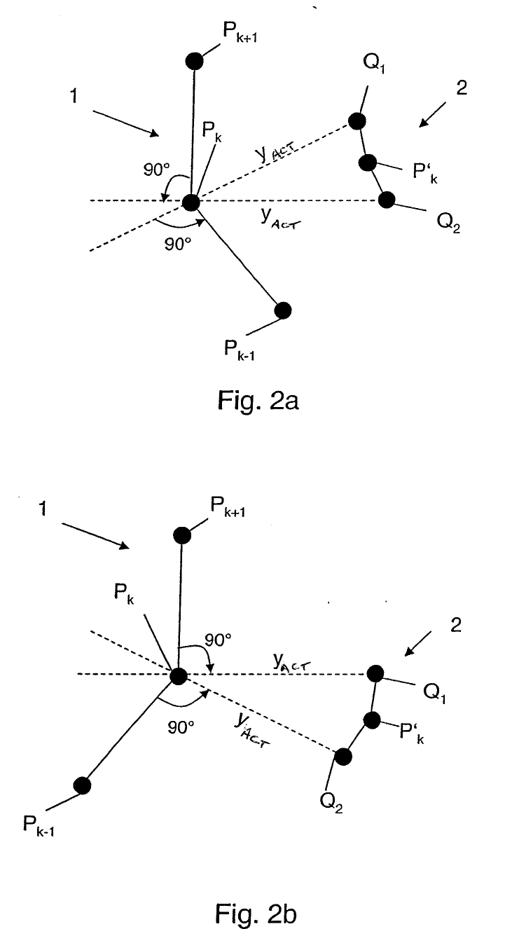

In a detailed view, FIG. 2 shows how the trajectory for the following aircraft (and thus the support point P′_{RP}) is determined. A support point Pₖ₋₁, which with directly precedes (in time) each support point Pₖ, and a support point Pₖ₊₁, which with directly follows (in time) each support point Pₖ, are considered on the trajectory 1 of the lead aircraft. Taking into account the lateral actual distance y_{act}, support points Q₁ and Q₂ on the trajectory 2 of the following aircraft are calculated.

In the case of a concave flying turn (FIG. 2a), a straight line through support point Q₁ and Pₖ stands in a perpendicular fashion on a straight line through support points Pₖ₋₁ and Pₖ. Simultaneously, a straight line through support point Q₂ and Pₖ stands perpendicular on a straight line through support points Pₖ and Pₖ₊₁. In the case of a convex flying turn (FIG. 2b), correspondingly, a straight line through support point Q₁ and Pₖ is perpendicular to a straight line through support points Pₖ and Pₖ₊₁ as well as a straight line through support point Q₂ and Pₖ is perpendicular to a straight line through support points Pₖ and Pₖ₋₁. Support point P′ₖ on the trajectory 2 of the following aircraft is therefore the center of gravity of the connection line between support point Q₁ and Q₂.

Correspondingly, it becomes possible to calculate additional support points P′ on the trajectory 2 of the following aircraft from known support points on the trajectory 1 of the lead aircraft. The reference point P′_{RP} on the trajectory of the following aircraft is the result of an interpolation between the adjacent support points P′ₓ and P′_{y} on the trajectory of the following aircraft which had been calculated by means of the above-described method from the support points Pₓ and P_{y} directly in front of and behind the reference point P_{RP} on the trajectory of the lead aircraft.

The longitudinal deviation Δx (FIG. 1) is calculated by integrating between the actual position P′_{act} of the following aircraft and the support point P′_{RP}, either with respect to the time or the distance. The integration typically takes place with respect to time, when a time is predetermined as the longitudinal distance Xₙₒₘ. Otherwise, the integration takes place with respect to the distance, when a distance is predetermined as the longitudinal distance xₙₒₘ. When the integration takes place with respect to the distance, the line segments of adjacent support points are in each case expediently integrated.

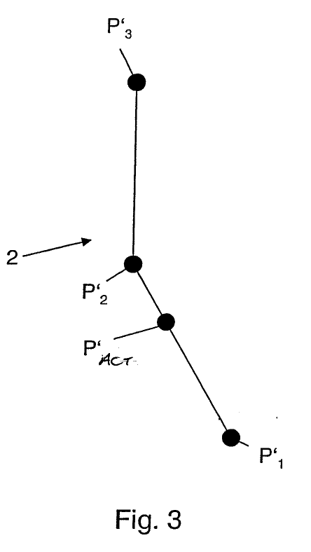

FIG. 3, which is a schematic representation for calculating speed and the nominal acceleration of a following aircraft shows the trajectory 2 of a following aircraft having several support points P′ (for example, P′₁, P′₂, and P′₃), as well as the actual position P′_{act} of the following aircraft. Now the speed V(P′₁P′₂) for that linear segment is calculated that is closest to the actual position P′_{act}. Subsequently, the speed V(P′₂P′₃) is calculated for the linear segment that follows with respect to the time:

$$V ( {P}_{1}^{′} {P}_{2}^{′} ) = \frac{x ( {P}_{2}^{′} ) - x ( {P}_{1}^{′} )}{t ( {P}_{2}^{′} ) - t ( {P}_{1}^{′} )}$$

$$V ( {P}_{2}^{′} {P}_{3}^{′} ) = \frac{x ( {P}_{3}^{′} ) - x ( {P}_{3}^{′} )}{t ( {P}_{3}^{′} ) - t ( {P}_{2}^{′} )}$$

wherein x indicates the space coordinate of the respect support point P′, and t indicates the time coordinate of the respective support point P′.

The nominal acceleration at position P′_{act} is therefore calculated as follows:

$$a ( {P}_{act}^{′} ) = \frac{V ( {P}_{2}^{′} {P}_{3}^{′} ) - V ( {P}_{1}^{′} {P}_{2}^{′} )}{t ( {P}_{2}^{′} ) - t ( {P}_{1}^{′} )}$$

The nominal speed at position P′_{act} is therefore calculated according to:

V(P′_{act})=V(P′₂P′₃)−a(P′_{act})[t(P′₂)−t(P′_{act})]

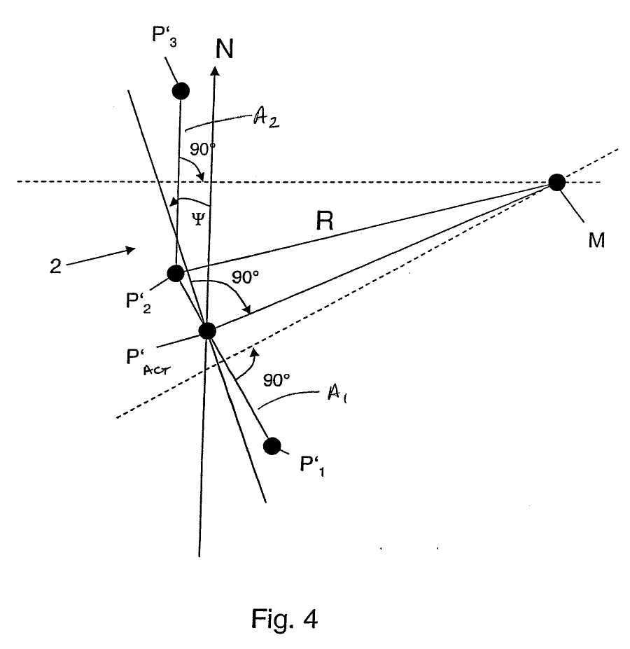

As shown schematically in FIG. 4, three support points P′₁, P′₂, and P′₃ and the resulting routes A₁ and A₂ are used to calculate the curvature radius R of the trajectory 2 of the following aircraft. A₁ indicates the route between P′₁ and P′₂ which is closest to the actual position P′_{act} of the following aircraft. A₂ indicates the route between P′₂ and P′₃ which follows directly with respect to the time. In this case, P′₂ is the support point directly following the actual position P′_{act} with respect to the time.

The curvature radius R is the radius of the circle with the center M on which P′₁, P′₂, and P′₃ are situated. The respective perpendicular bisector lines of routes A₁ and A₂ mutually intersect in point M. The route between M and P′₂ can therefore be called the radius R of the curvature. The curvature of the turn of the trajectory, according to the definition, is calculated by 1/R, a positive preceding sign being added for right turns and a negative preceding sign being added for left turns.

The ground course angle Ψ is calculated from the angle at the actual position P′_{act} of the following aircraft between the perpendicular line R₁ on the connection MP between point M and the actual position P′_{act} and the true north N.

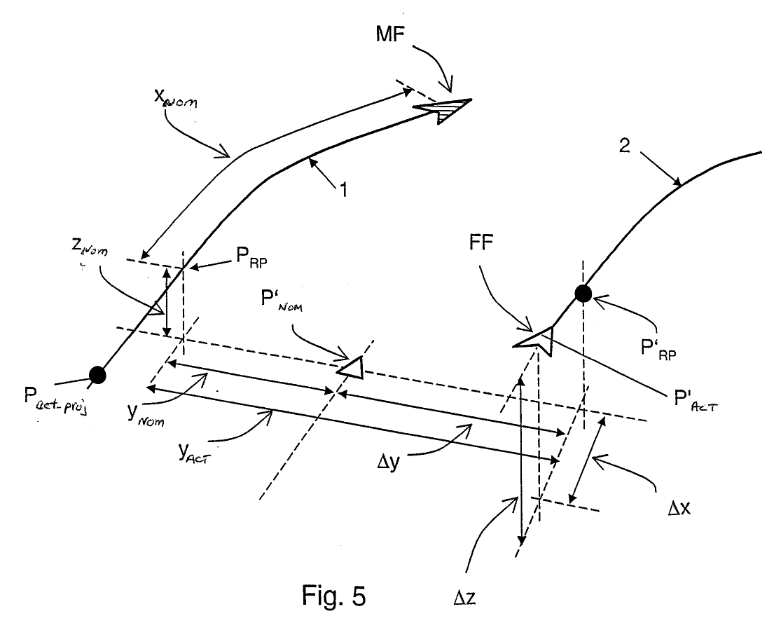

FIG. 5, which is a schematic three-dimensional representation of a situation in a formation flight, shows the deviation of the trajectory of the following aircraft from the predetermined nominal values with respect to the individual spatial directions. A lead aircraft MF is shown on its trajectory 1 and a following aircraft on the trajectory 2 as well as the reference points P_{RP} and P′_{RP} on the respective trajectories 1, 2. On the trajectory 2, the following aircraft FF is at the actual position P′_{act}. The nominal position is marked P′ₙₒₘ. The figure also shows the respective nominal values yₙₒₘ, Xₙₒₘ, zₙₒₘ as well as the actual values y_{act}, X_{act}, z_{act} with respect to the respective spatial direction and the deviations Δx, Δy, Δz linked therewith.

Compensating the vertical deviation requires calculation of a climbing rate. For this purpose, the climbing rate of the lead aircraft is calculated. For this purpose, the actual position P′_{act} of the following aircraft is first projected onto point P_{act}_{_{—}}ₚᵣₒⱼ on the trajectory 1 of the lead aircraft. From two support points (not shown) directly adjacent thereto (one having an earlier time coordinate and the other having a later time coordinate than the projected support point P_{act}_{_{—}}ₚᵣₒⱼ), the climbing rate is calculated. Expediently, additional support points on the trajectory 1 can be included in the calculation, for example, by means of known filtering or interpolation methods.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method of flight control for a plurality of aircraft flying in formation with respect to one another, with correction signals being generated for an autopilot system or a command display in order to allow one or more following aircraft within the formation to follow a lead aircraft in a predeterminable relative position, said method comprising:
at each instantaneous position P′_{act} of the following aircraft, calculating a trajectory of the following aircraft, which is parallel to the trajectory of the lead aircraft, with the calculated trajectory of the following aircraft running through an instantaneous actual position P′_{act} and a reference point P′_{RP}, that is the projection of a point P_{RP} which is separated by the longitudinal nominal distance xₙₒₘ between the lead aircraft and the following aircraft, on the trajectory of the lead aircraft, taking into account the lateral and vertical actual distances y_{act} and z_{act} between the trajectory of the lead aircraft and that of the following aircraft;
calculating the trajectory of the following aircraft taking into account the lateral actual distance y_{act} from the trajectory of the lead aircraft by the determination of support points P′ on the trajectory of the following aircraft which have the same time coordinates as the corresponding support points on the trajectory of the lead aircraft; and
determining correction signals by the steps of
measuring longitudinal actual distance x_{act}, lateral actual distance y_{act} and vertical actual distance z_{act} between the trajectory of the lead aircraft and that of the following aircraft at the instantaneous position P′_{act} of the following aircraft;
calculating a longitudinal deviation Δx, a vertical deviation Δz and a lateral deviation Δy of the instantaneous actual position P′_{act} and of the nominal position P′ₙₒₘ of the following aircraft from the respective nominal values xₙₒₘ, zₙₒₘ, yₙₒₘ and the measured actual values x_{act}, z_{act}, y_{act};
calculating nominal speed and nominal acceleration of the following aircraft at the point P′_{RP};
calculating a nominal curvature, a nominal climbing rate and a nominal curvature angle Ψ of the trajectory of the following aircraft at the instantaneous position P′_{act} of the following aircraft.

2. The method according to claim 1, wherein:
a plurality of support points P are determined on the trajectory of the lead aircraft; and
for the support points P, the space coordinates are known and a time coordinate is known with respect to a time basis which is uniform for the formation.

3. The method according to claim 1, wherein a ground course angle Ψ of the following aircraft is determined as the angle between a direction of the trajectory (2) of the following aircraft and its instantaneous position P′_{act} and the true north.

4. The method according to claim 1, wherein the reference point P_{RP} and the reference point P′_{RP} have the same time coordinate.

5. The method according to claim 2, wherein time-tagged support points P on the trajectory of the lead aircraft are equidistant to one another.

6. The method according to claim 1, wherein the longitudinal deviation Δx in a length indication is determined as the sum of individual length segments adjacent support points between the support point of reference point P′_{RP} and the actual position P′_{act} of the following aircraft.

7. The method according to claim 1, wherein the longitudinal deviation Δx in a time indication is determined as the difference between the time coordinate of the support point of the reference point P′_{RP} and the actual position P′_{act} of the following aircraft.

8. The method according to claim 1, wherein the trajectory of the lead aircraft is calculated as the trajectory of a following aircraft relative to a lead aircraft of a higher-ranking formation.

9. The method according to claim 1, wherein the lead aircraft transmits an actual spatial position and an actual time coordinate to at least one following aircraft, by radio.
